(19) United States
(12) Patent Application Publication
(10) Pub. No.: US 2007/0152968 A1
(43) Pub. Date: Jul. 5, 2007

(54) Cursor control apparatus

(76) Inventor: Kuo-Shu Cheng, Hsin-Tien City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/503,077

(22) Filed: Aug. 14, 2006

(30) Foreign Application Priority Data
Dec. 29, 2005 (CN) 200520038152.7

(51) Int. Cl. G09G 5/08

(52) U.S. Cl. 345/163

(57) ABSTRACT

A cursor control apparatus that allows a user to double-click the left key. A second left key is added to the traditional cursor control apparatus. The user can press the second left key once to achieve the multi-clicking effect. The speed of performing shooting actions in a game application or processing a document file in a computer is thereby increased.

### BACKGROUND OF THE INVENTION

1. Field of the Invention

The present invention relates to a cursor control apparatus. In particular, this invention relates to a cursor control apparatus that allows a user to double-click the left key.

2. Description of the Related Art

Reference is made to FIGS. 1, 2 and 3. FIG. 1 is a schematic diagram of the appearance of the cursor control apparatus of the prior art. FIG. 2 is a block diagram of the optical cursor control apparatus of the prior art. FIG. 3 is a block diagram of the roller cursor control apparatus of the prior art. The cursor control apparatus includes a first left key 1, a middle key 2, a right key 3, a displacement sensor 4, and a processor 5.

A user can perform a shooting action in a game application by pressing the first left key 1. When the user performs the shooting action, the user presses the upper cover of the left key to trigger the left key micro-movement switch to generate a first left key single-click signal L in the key input unit 7 so that the shooting action is performed. Because the period for completing the shooting action is too long and the left key has to be pressed once for every shooting action, the user cannot rapidly execute the shooting actions in the game application. The entertainment value of the game is therefore lowered, due to this restriction of the prior art technology.

Likewise, when the user wants to process a document file, the user needs to continually press the first left key 1 twice, or use other options available only by using the menu options available in the application, to open the document file. The operation speed is low and the process is complex so that the efficiency of computer operation is affected.

### SUMMARY OF THE INVENTION

One particular aspect of the present invention is to provide a cursor control apparatus that allows a user to double-click the left key. A second left key is added to the traditional cursor control apparatus. The user can press the second left key once to achieve a multi-clicking effect. The speed of performing the shooting actions in a game application and processing a document file in a computer are thereby increased.

The cursor control apparatus having a double-click the left key includes a first left key, a middle key, a right key, a second left key, a displacement sensor, and a processor. The second left key generates a second left key single-click signal to the processor, and the processor converts the second left key single-click signal into a left key double-click signal. The left key double-click signal is transmitted to a computing apparatus via the signal transmitting terminal to achieve the effect of continually pressing the left key twice.

For further understanding of the invention, reference is made to the following detailed description illustrating the embodiments and examples of the invention. The description is only for illustrating the invention and is not intended to be considered limiting of the scope of the claim.

### BRIEF DESCRIPTION OF THE DRAWINGS

The drawings included herein provide a further understanding of the invention. A brief introduction of the drawings is as follows:

FIG. 1A is a top view of the of the cursor control apparatus of the prior art;

FIG. 1B is a bottom view of the of the cursor control apparatus of the prior art;

FIG. 2 is a block diagram of the optical cursor control apparatus of the prior art;

FIG. 3 is a block diagram of the roller cursor control apparatus of the prior art;

FIG. 4A is a top view of the of the cursor control apparatus of the present invention;

FIG. 4B is a bottom view of the of the cursor control apparatus of the present invention;

FIG. 5 is a block diagram of the optical cursor control apparatus of the present invention;

FIG. 6 is a block diagram of the roller cursor control apparatus of the present invention;

FIG. 7 is a block diagram of the second left key single-click signal converted into a left key double-click signal of the present invention; and

FIG. 8 is a circuit diagram of the vibrator chip of the present invention.

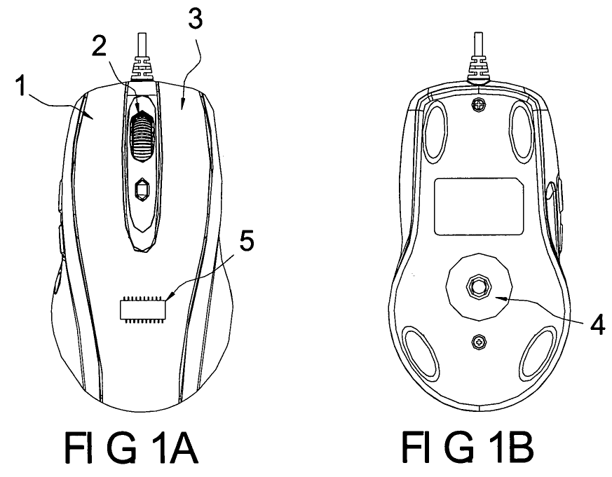

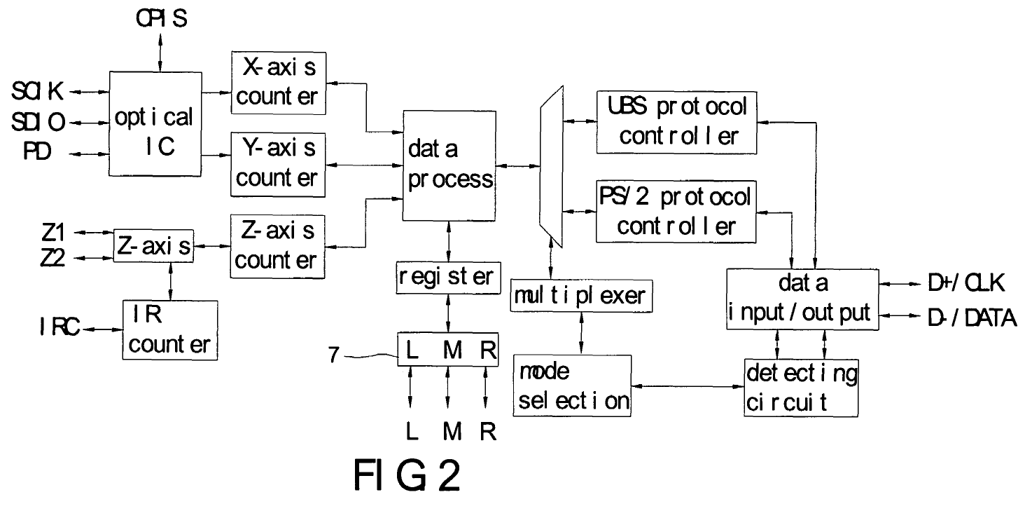

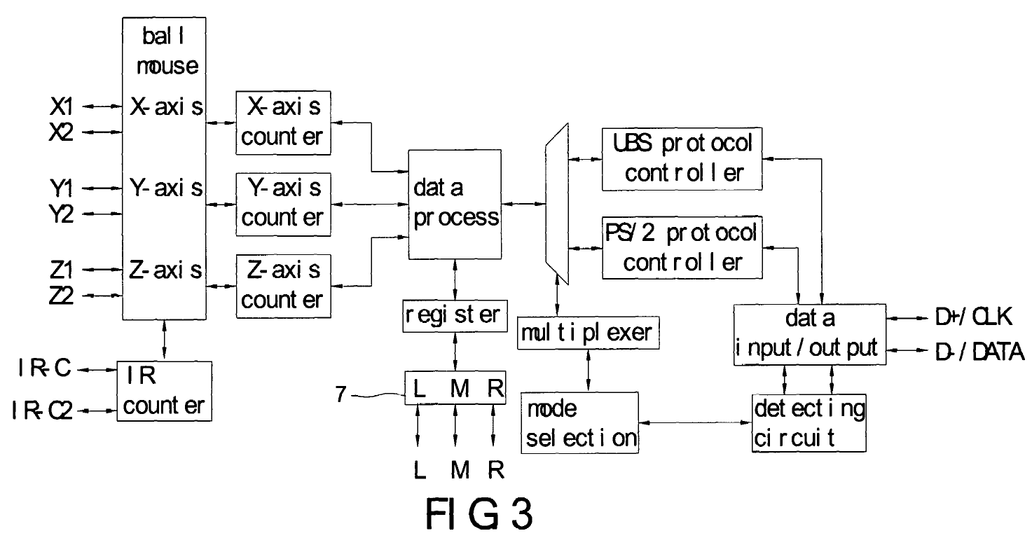

### DETAILED DESCRIPTION OF THE PREFERRED EMBODIMENTS

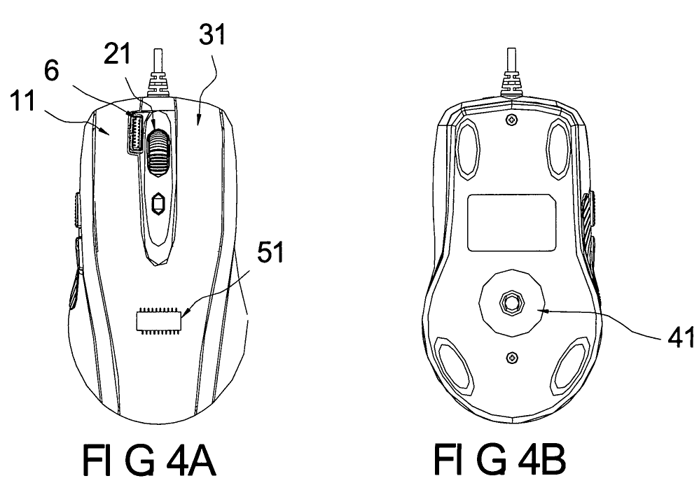

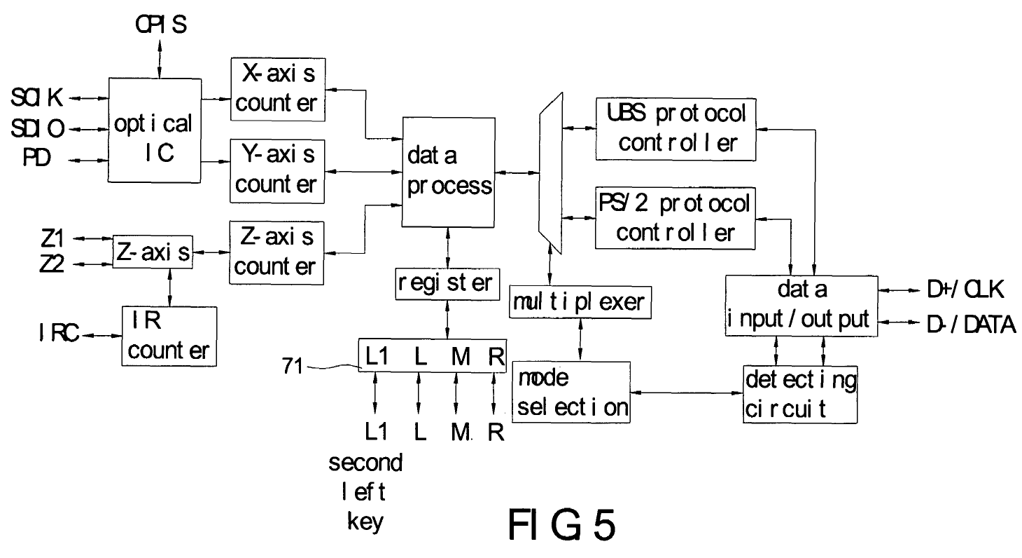

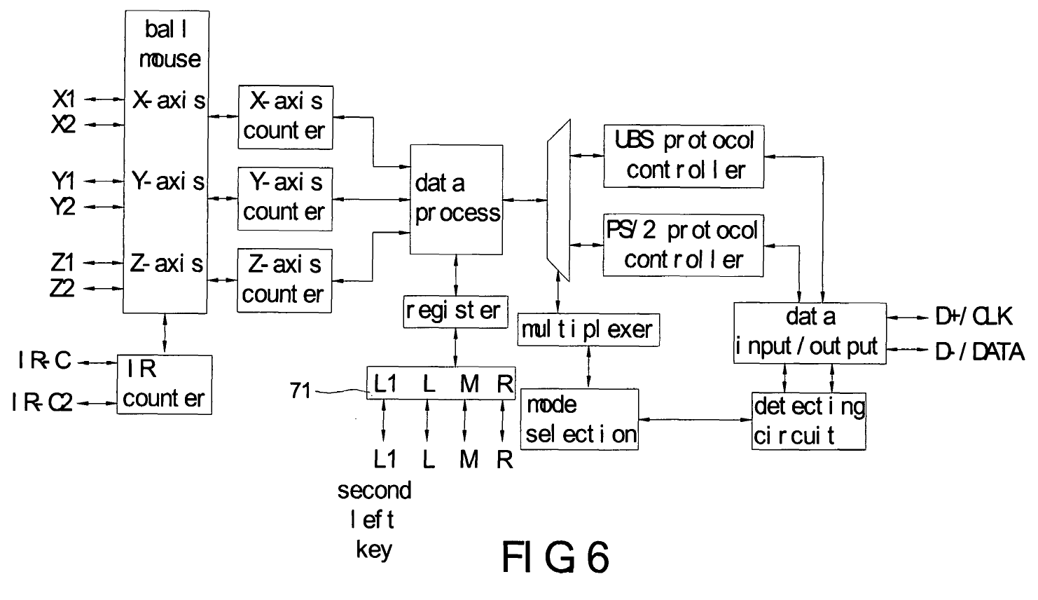

Reference is made to FIGS. 4-6. FIG. 4 is a schematic diagram of the appearance of the cursor control apparatus of the present invention. FIG. 5 is a block diagram of the optical cursor control apparatus of the present invention. FIG. 6 is a block diagram of the roller cursor control apparatus of the present invention. The cursor control apparatus includes a first left key 11, a middle key 21, a right key 31, a displacement sensor 41, a processor 51, and a second left key 6. The second left key 6 is adjacent to the first left key 11. The first left key 11, the middle key 21, or the right key 31 can utilize a micro-movement key switch, a touching thin film switch, or a capacitor sensing switch to generate a single single-click signal, such as a first left key single-click signal L, a middle single-click signal M; a right single-click signal R in the key input unit 71. Similarly, the second left key 6 can also utilize the described switches to generate a second left key single-click signal L1.

The processor 51 can be a traditional microprocessor or a cursor control circuit with a vibrator chip (not shown in the figure) for scanning the first left key 11 and the second left key 6 and converting the second left key single-click signal L1 generated from the second left key 6 into a left key double-click signal. The left key double-click signal is transmitted to a computing apparatus via the signal transmitting terminal (not shown in the figure) of the processor 51 to achieve the effect of double-clicking. Therefore, the user can rapidly perform the shooting actions in a game application or process a computer document file. The signal transmitting terminal can be a USB, a PS2, an RS232, a SPI,I2C, a wireless transmitting terminal, or an IR (Infrared Radio) transmitting terminal.

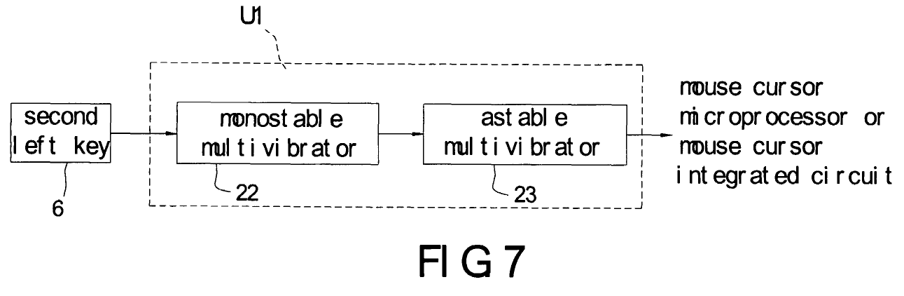

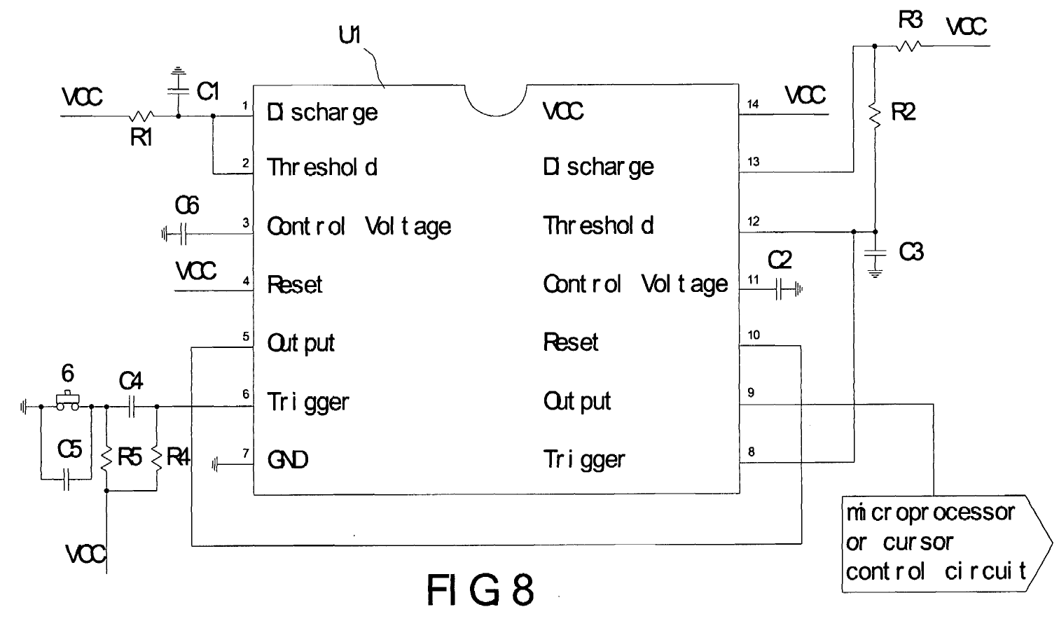

Reference is made to FIGS. 7 and 8. FIG. 7 shows a block diagram of the second left key single-click signal converted into a left key double-click signal of the present invention. FIG. 8 is a circuit diagram of the vibrator chip of the present invention. The vibrator chip is an NE556 chip and is designed as a monostable multivibrator 22 and an astable multivibrator 23. The NE556 chip comprises two NE555 chips. The monostable multivibrator 22 includes the vibrator chip U1, resistors R1, R4 and R5, and capacitors C1, C4, C5 and C6. The astable multivibrator 23 includes the vibrator chip U1, resistors R2 and R3, and capacitors C2 and C3.

The pulse width of the astable multivibrator 23 is smaller than that of the monostable multivibrator 22. The pulse width of the monostable multivibrator 22 is determined by the resistor R1 and the capacitor C1. When the user presses the second left key 6, the monostable multivibrator 22 is triggered to make the astable multivibrator 23 be enabled to oscillate. The pulse width of the astable multivibrator 23 is determined by the resistors R2, R3 and the capacitor C3. When the output of the monostable multivibrator 22 is recovered, the astable multivibrator 23 is disabled. That means the astable multivibrator 23 stops oscillating. The number of pulses outputted from the astable multivibrator 23 is controlled by the width of the pulse outputted from the monostable multivibrator 22.

Therefore, the second left key single-click signal L1 generated from the second left key 6 is converted into a left key double-click signal via the monostable multivibrator 22 and the astable multivibrator 23. Next, the left key double-click signal is transmitted to the computing apparatus via the signal transmitting terminal of the processor 51 to achieve the effect of double-clicking. Thereby, the user can rapidly perform the shooting actions in the game application or process the computer document file.

In this embodiment, the processor 51 scans the first left key 11 and the second left key 6 that are independent to each other. In another embodiment, the processor 51 scans the first left key 11 and the second left key 6 that are cooperated to each other in parallel. The functions and locations of the first left key 11 and the second left key 6 are interchangeable.

Furthermore, the clicking number generated from pressing the second left key 6 once is controlled by an application in the computing apparatus or a setting key (not shown in the figure) located on the cursor control apparatus. That means the second left key single-click signal is converted into a multi-click signal. The time and period required for a signal click is also controlled. Therefore, when the cursor moves rapidly, the file displayed on the computing apparatus still can be double-clicked well.

The description above only illustrates specific embodiments and examples of the invention. The invention should therefore cover various modifications and variations made to the herein-described structure and operations of the invention, provided they fall within the scope of the invention as defined in the following appended claims.

What is claimed is:

1. A cursor control apparatus, having a first left key, a middle key, a right key, and a processor with a signal transmitting terminal, wherein the processor individually processes single-click signals generated from the first left key, the middle key, and the right key, and transmits the single-click signals to a computing apparatus via the signal transmitting terminal, wherein the cursor control apparatus further comprises:
a second left key, generating a second left key single-click signal to the processor, the processor converts the second left key single-click signal into a left key double-click signal, and the left key double-click signal is transmitted to the computing apparatus via the signal transmitting terminal.

2. The cursor control apparatus as claimed in claim 1, wherein the processor is a microprocessor or a cursor control circuit having a converting means that converts the second left key single-click signal into the left key double-click signal.

3. The cursor control apparatus as claimed in claim 1, wherein the processor is a microprocessor or a cursor control circuit, the cursor control circuit cooperates with a vibrator chip.

4. The cursor control apparatus as claimed in claim 3, wherein the vibrator chip comprises a monostable multivibrator and an astable multivibrator.

5. The cursor control apparatus as claimed in claim 3, wherein the vibrator chip comprises two NE 555 chips.

6. The cursor control apparatus as claimed in claim 3, wherein the vibrator chip is an NE556 chip.

7. The cursor control apparatus as claimed in claim 1, wherein the processor is a microprocessor or a cursor control circuit having a converting means that converts the second left key single-click signal into the left key double-click signal, and the processor scans the first left key and the second left key that are independent to each other.

8. The cursor control apparatus as claimed in claim 1, wherein the second left key is adjacent to the first left key.

9. The cursor control apparatus as claimed in claim 1, wherein a period and a time interval required for the processor that converts the second left key single-click signal into a left key double-click signal that is controlled by an application located in the computing apparatus.

10. The cursor control apparatus as claimed in claim 1, further comprising a setting key that controls a period and a time interval required for the processor that converts the second left key single-click signal into a left key double-click signal.

11. The cursor control apparatus as claimed in claim 1, wherein the signal transmitting terminal is a USB, a PS2, an RS232, a SPI,I2C, a wireless transmitting terminal, or an IR transmitting terminal.

12. The cursor control apparatus as claimed in claim 1, wherein the second left key utilizes a micro-movement key switch, a touching thin film switch, or a capacitor sensing switch to generate the second left key single-click signal.

13. The cursor control apparatus as claimed in claim 1, wherein a clicking number generated by pressing the second left key once is determined by a user's requirement.

14. The cursor control apparatus as claimed in claim 1, wherein the processor is a microprocessor or a cursor control circuit having a converting means that converts the second left key single-click signal into the left key double-click signal, and the processor scans the first left key and the second left key that are cooperated to each other in parallel.

15. The cursor control apparatus as claimed in claim 1, wherein the functions of the first left key and the second left key are interchangeable.
